(19) United States
(12) Patent Application Publication
(10) Pub. No.: US 2009/0187827 A1
(43) Pub. Date: Jul. 23, 2009

(54) METHOD FOR DISPLAYING A SEQUENCE OF IMAGES WITH DIFFERENT SIZES OF THE DISPLAYED IMAGES

(76) Inventor: Matthias Drobnitzky, Spardorf (DE)

Correspondence Address: SCHIFF HARDIN, LLP;PATENT DEPARTMENT, 6600 SEARS TOWER, CHICAGO, IL, 60606-6473, US

(21) Appl. No.: 12/354,397

(22) Filed: Jan. 15, 2009

(30) Foreign Application Priority Data
Jan. 18, 2008 (DE) 10 2008 005 149.7

(51) Int. Cl. G06F 3/00

(52) U.S. Cl. 715/730

(57) ABSTRACT

A computer interactively receives a selection command from a user for an internally contiguous sub-range of images of a sequence within the sequence. The computer outputs the images of the internally contiguous sub-range to the user via a viewing device in a first presentation size that is uniform for the images of the internally contiguous sub-range. The computer outputs images of the sequence that lie outside of the internally contiguous sub-range to the user via the viewing device simultaneously with the images of the internally contiguous sub-range with a respective second presentation size that is smaller than the first presentation size. The geometric arrangement of the output images on the viewing device forms a geometric sequence. The order of the output images coincides with the order of the sequence of images.

### BACKGROUND OF THE INVENTION

1. Field of the Invention

The present invention concerns a presentation method for a sequence of images at a viewing device, of the type wherein a computer interactively receives a selection command from a user for an internally contiguous sub-range of images within said sequence, and wherein the computer outputs the images of the internally contiguous sub-range to the user via the viewing device in a first presentation size that is uniform for the images of the internally contiguous sub-range.

The present invention furthermore concerns a computer-readable medium encoded with machine code that causes a computer to execute such a presentation method.

The present invention also concerns a computer that is programmed by such programming instructions

2. Description of the Prior Art

Methods of the above general type are known.

For example, the images can form a time sequence. Perfusion images that show how a contrast agent perfuses a blood vessel system are an example of a time sequence. Alternatively, the images can be slice images (for example) that form a slice image stack running orthogonally along the height axis of a person (i.e. from head to foot). For example, these can be projections of a static subject that were acquired in succession at various angles.

Modern radiological slice image methods (for example magnetic resonance applications and computer tomography) often confront the user (normally a physician) with the necessity to be able to view many images in order to be able to identify a few images with diagnostic relevance. In the prior art, the complete surveying normally ensues group-by-group via simultaneous presentation of correspondingly many small single images on the viewing device. Alternatively, every single image of the sequence can be presented separately. Both procedures are not intuitive.

A representation method for a sequence of images via a viewing device is known from United States Patent Application Publication No. 2007/237372, wherein a computer interactively receives a selection command from a user for a sub-range of a sequence of images that is internally contiguous within the sequence, and the computer outputs the images of the internally contiguous sub-range to the user via the viewing device in a first presentation size that is uniform for the images of the internally contiguous sub-range. Furthermore, from this published application it is known to output a corresponding image of another sequence simultaneously with the images so presented. The size of the additional output image corresponds to the size of the first cited images.

A presentation method for a sequence of images via a viewing device is known from Untied States Patent Application Publication No. 2003/095147, wherein a computer interactively receives a selection command from a user for a sub-range of a sequence of images that is internally contiguous within said sequence, and said computer outputs the images of the internally contiguous sub-range to the user via the viewing device in a first presentation size that is uniform for the images of the internally contiguous sub-range. Furthermore, in this publication application it is incidentally mentioned that a number of miniature images can be output in a different image region simultaneously with a presented image to be evaluated.

A presentation method for images via a viewing device is known from United States Patent Application Publication No. 2007/0165923 in which multiple images of an examination subject can be simultaneously output to a user via the viewing device. The sizes of the output images are the same among one another.

### SUMMARY OF THE INVENTION

An object of the present invention is to provide possibilities by means of which a simpler finding is possible.

A further object is to provide a computer-medium on which such a computer program is stored that causes such a method to be executed by a computer. It is also an object to provide a computer that is programmed with such a computer program.

According to the invention, in a presentation method of the aforementioned type it is additionally provided that the computer outputs images of the sequence that lie outside of the internally contiguous sub-range to the user via the viewing device simultaneously with the images of the internally contiguous sub-range, that the computer outputs each of the output images lying outside of the internally contiguous sub-range in a respective second presentation size that is smaller than the first presentation size, that the geometric arrangement of the output images on the viewing device forms a geometric sequence, and that the order of the output images coincides with the order of the sequence of images.

With the procedure according to the invention it is possible to present the images of the selected range (i.e. of the internally contiguous sub-range) relatively large so that a good ability to recognize the respective image content is provided with regard to these images. Moreover, an easy ability to recognize the position of the selected range in the sequence is possible due to the smaller presentation of the additional images.

It is possible for the sequence of images to be already predetermined for the computer (=status). Alternatively, it is possible that the computer receives the sequence of images (=process).

It is possible for the internally contiguous sub-range to correspond with to multiple images, but it is preferable for the internally contiguous sub-range to correspond to a single image.

The computer can simultaneously output all images of the sequence, but the computer normally will not output all images of the sequence. In this case the sequence contains further images in addition to the output images. In this case the computer advantageously automatically determines the output images lying outside of the internally contiguous sub-range using said internally contiguous sub-range.

It is possible, independent of the position of the internally contiguous sub-range, that only images lying before the internally contiguous sub-range in the sequence of images are always output as well in addition to the images of the internally contiguous sub-range. The reverse procedure is also possible. It is preferable, in the event that the internally contiguous sub-range encompasses neither the first nor the last image of the sequence, for the computer to output at least one of the respective images upstream and downstream of the internally contiguous sub-range simultaneously with the images of the internally contiguous sub-range.

The second presentation size can be uniform for the output images lying outside of the internally contiguous sub-range. It is preferable, however, that the respective second presentation size decreases monotonically (but not necessarily strongly monotonically) with the distance of the corresponding output image from the internally contiguous sub-range.

It is preferred that the output images are arranged in at least one inwardly running spiral on the viewing device, starting from the internally contiguous sub-range. With this procedure, a particularly good recognition of the position of the internally contiguous sub-range in the sequence of images is intuitively possible. The combination of the spiral formation with a distance-dependent second presentation size is particularly preferable.

It is possible that the images of the sequence are assembled into groups. In this case it can be provided that the number of presented images of the groups increases with the distance of the respective group from the internally contiguous sub-range. This procedure even further facilitates the intuitive position determination of the internally contiguous sub-range. This last cited mode of operation is particularly preferable in combination with the distance-dependent second presentation size mentioned in the preceding and/or the spiral-shaped arrangement of the images.

The selection command can be an absolute selection command (for example “internally contiguous sub-range=images 50 through 55 of 390”). It is preferable, however, for the selection command to be a shift instruction to shift the internally contiguous sub-range of the sequence (for example “shift internally contiguous sub-range 5 images forward from current position”).

### BRIEF DESCRIPTION OF THE DRAWINGS

FIG. 1 schematically illustrates a computer loaded with a computer-readable medium, included with programming instructions, that program the computer to implement a method in accordance with the present invention.

FIG. 2 is a flowchart illustrating an embodiment of the inventive presentation method.

FIG. 3 schematically illustrates a first embodiment for presentation of images at a viewing device in accordance with the present invention.

FIG. 4 schematically illustrates a second embodiment for presenting images at a viewing device in accordance with the present invention.

### DESCRIPTION OF THE PREFERRED EMBODIMENTS

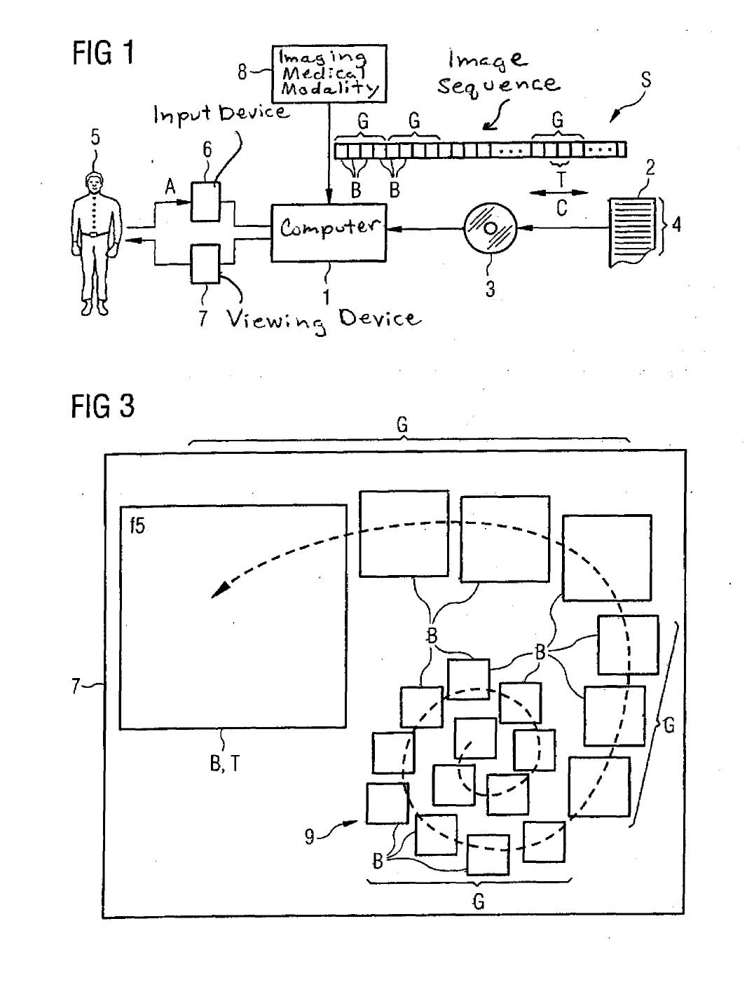

According to FIG. 1, a computer 1 is programmed with a computer program 2. The computer program 2 can have been supplied to the computer via a computer-computer connection (for example a LAN or the Internet; not shown in FIG. 1), for example. Alternatively, it is possible to supply the computer program 2 to the computer 1 via a data medium 3 on which the computer program 2 is stored in an (exclusively) machine-readable (electronic) form. The data medium 3 is represented as a CD-ROM in FIG. 1. However, it can be fashioned otherwise, for example as a USB memory stick or as a memory card.

The computer program 2 embodies machine code 4 that can be directly executed by the computer 1. The computer program 2 can be addressed by a user 5 via a typical input device 6. For example, the addressing ensues by means of a typical address command, for example a double-click of a mouse on a symbol that is output via a viewing device 7 to the user 5 and is linked inside the computer with the computer program 2. When the computer program 2 is called, the computer 1 subsequently executes the computer program 2. The execution of the computer program 2 by the computer 1 has the effect that the computer 1 executes a presentation method which is subsequently explained in detail in connection with FIG. 1 through 4.

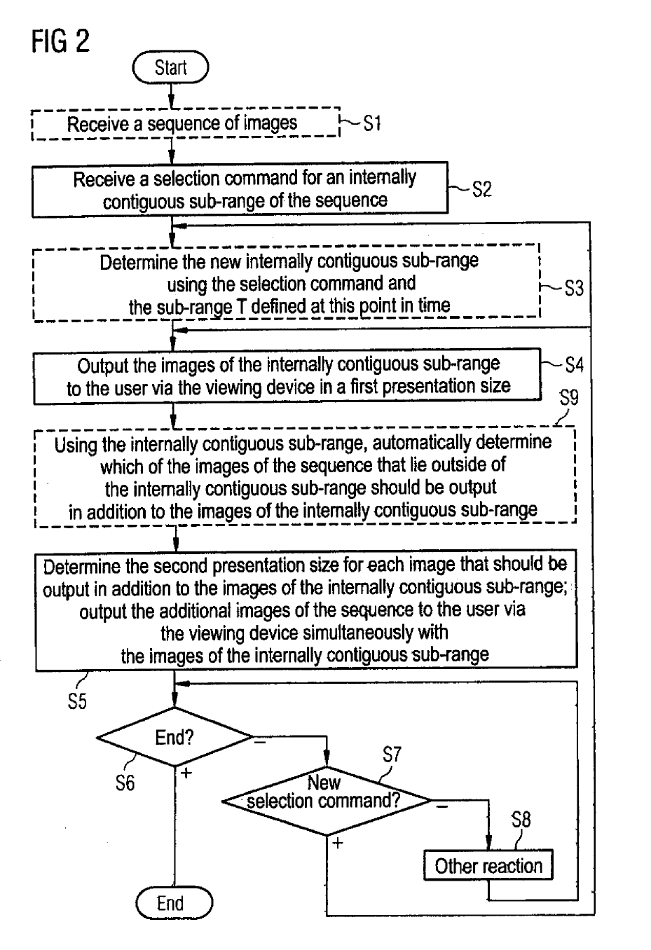

According to FIG. 2, in Step S1 the computer 1 initially receives a sequence S of images B. The sequence S of images B can be supplied to the computer from an imaging medical modality 8, for example. Examples of such modalities are a computer tomograph, a C-arm x-ray system, a ultrasound tomograph or a magnetic resonance system.

Step S1 is merely optional and is shown only with dashed lines in FIG. 2 for this reason. Alternatively, for example, it is considered that the sequence S of images B has already been provided to the computer 1 (status), or that the computer 1 automatically determines the sequence S of images B using other data already provided to it or currently available data.

In Step S2, the computer 1 receives a selection command A from the user 5 for an internally contiguous sub-range T of the sequence S of images B. Reception of the selection command A ensues interactively. The user 5 can thus change or, respectively, provide the selection command A again at any time, and the computer 1 reacts correspondingly.

It is possible that the selection command A is an absolute selection command (“sub-range T should begin with image x and end with image y”). However, as indicated by a double arrow C in FIG. 1, the selection command A is normally a shift instruction (“displace sub-range T, starting from currently provided sub-range T, forward or backward by x images”). The terms “forward” and “backward” are directions that are defined by the order of images B in the sequence S. In a typical case of the determination of the shift using a mouse movement, the speed of the mouse movement can corresponding with the speed or the magnitude of the shift of the sub-range T, for example.

If the selection command A is a shift instruction, a Step S3 is required. The Step S3 is represented only with dashed lines in FIG. 2 since it is not absolutely necessary.

In Step S3, the computer 1 determines the new sub-range T of the sequence S using the selection command A and the sub-range T defined at this point in time. The sub-range T is hereby always internally contiguous, regardless of whether it is directly provide in Step S2 or is defined by the computer 1 in Step S3. It thus includes all images B of the sequence S that are defined by the limits of the sub-range T. In other words: if an image x and an image y are components of the sub-range T, every image z of the sequence S that lies between the images x and y is also a component of the internally contiguous sub-range T.

The extent of the internally contiguous sub-range T can be arbitrarily selected. Alternatively, it can be hard-set or adjustable. It can be greater than one, or it can assume a value of one. In this (presently preferred) case, the internally contiguous sub-range T is a single image B of the sequence S (singular case).

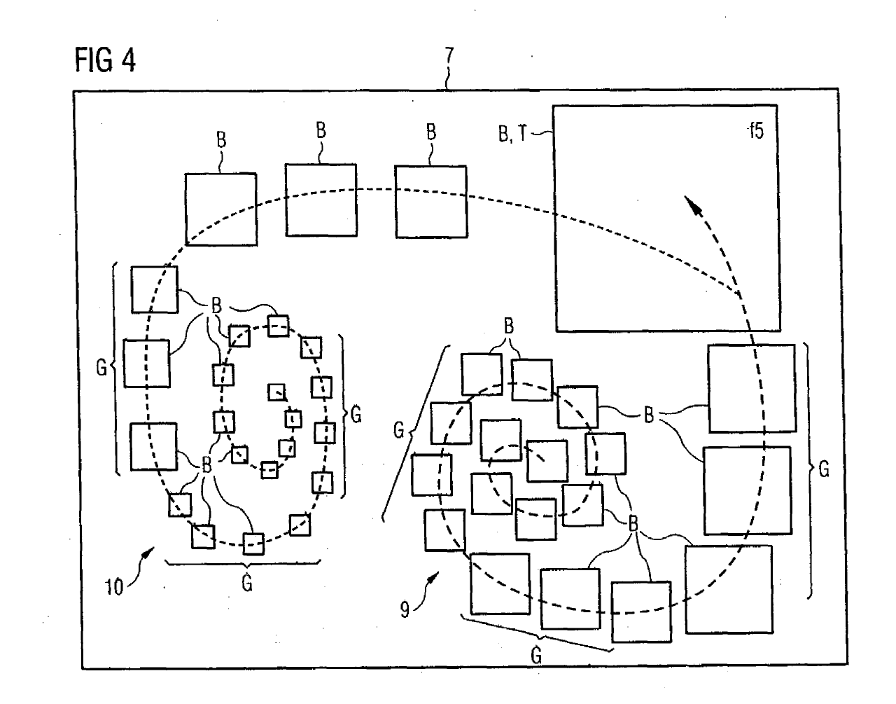

In Step S4, the computer 1 outputs the images B of the internally contiguous sub-range T to the user 5 via the viewing device 7. According to FIGS. 3 and 4, the images B of the internally contiguous sub-range T are hereby presented in a first presentation size that is uniform for all images B of the internally contiguous sub-range T. In the case presented in FIGS. 3 and 4 (that the sub-range T corresponds with a single image B), the word “uniform” is trivial since a single image B can naturally only be presented in a single presentation size.

In Step S5, the computer 1 outputs additional images B of the sequence S to the user 5 via the viewing device 7 simultaneously with the images B of the internally contiguous sub-range T. These additional images B hereby lie outside of the internally contiguous sub-range T. Examples of such presentations are found in FIGS. 3 and 4. According to FIGS. 3 and 4, the geometric arrangement of the output images B on the viewing device 7 forms a geometric sequence. The order of the output images B (thus the geometric sequence) hereby corresponds with the order in the sequence S of images B. The significant difference between the presentations according to FIG. 3 and according to FIG. 4 is that in FIG. 3 the additional images B (thus the images B outside of the internally contiguous sub-range T) lie only on one side of the internally contiguous sub-range T, thus are either exclusively upstream or exclusively downstream of the internally contiguous sub-range T in the sequence S of images B. In contrast to this, in the presentation from FIG. 4 at least one of the additional output images B is respectively upstream and downstream of the internally contiguous sub-range T. The mode of operation from FIG. 4 is hereby naturally only possible when the internally contiguous sub-range T encompasses neither the first nor the last image B of the sequence S.

According to FIGS. 3 and 4, the additional images B are output in second presentation sizes that are smaller than the first presentation size. It is possible that the second presentation size is uniform for all additional output images B (thus those lying outside of the internally contiguous sub-range T) of the sequence S. According to FIGS. 3 and 4, however, the respective second presentation size of an output image B decreases monotonically with the distance of the corresponding image B from the internally contiguous sub-range T. In this case Step S5 is designed (as shown in FIG. 2) such that the corresponding second presentation size is also determined for each additional image B in the framework of Step S5.

The arrangement of the output images B can in principle be arbitrarily selected. For example, it is possible to arrange the output images B in the shape of a sinuous line on the viewing device 7. However, as shown in FIGS. 3 and 4 it is preferable to arrange the output images B (starting from the internally contiguous sub-range T) on the viewing device 7 in an inwardly-running spiral 9 (see FIG. 3) or in two such spirals 9, 10.

In Step S6, the computer 1 checks whether the presentation method according to the invention should be ended. If this is not the case, the computer 1 transitions to Step S7. In Step S7 the computer 1 checks whether a new selection command A has been provided to it. If this is the case, the computer 1 returns to Step S4 or, respectively, to Step S3 (depending on the type of selection command A). Otherwise, the computer 1 transitions to Step S8, in which it executes a different reaction.

In principle it is possible to output all images B of the sequence S simultaneously via the viewing device 7. In many cases, however, the sequence S will comprise so many images B that a simultaneous output of all images B is not possible or not reasonable. In this case, the procedure illustrated above in connection with FIG. 2 must be expanded with a Step S9. Step S9 is shown in dashed lines in FIG. 2 since it is not absolutely necessary in each case.

In Step S9, using the internally contiguous sub-range T the computer 1 automatically determines which of the images B of the sequence S that lie outside of the internally contiguous sub-range T should be output in addition to the images B of the internally contiguous sub-range T. For example, starting from the internally contiguous sub-range T the computer 1 can select every third, every fifth, every tenth or generally every n-th preceding and/or subsequent image B in the sequence S and output them in addition to the images B of the internally contiguous sub-range T.

The latter-cited procedure (to output every n-th image B as well) is always realizable. It is in particular realizable even when the images B of the sequence S are combined into groups G. Each group G hereby contains multiple images B of the sequence S and is internally contiguous, analogous to the sub-range T. In many cases, each group G contains the same number of images B, for example 5, 8, 10 or 20 images B. If the images B of the sequence S are combined into groups G, as an alternative to a uniformly spaced selection of the images B it is possible that the number of shown images B of the groups G increases with the distance of the respective group G from the internally contiguous sub-range T. For example, every fifth image B can be output as well in the group G contained in the internally contiguous sub-range, every third image B in the group G immediately adjoining this group G [sic], every second image in the next group G in turn and all images B in the following group G or, respectively, the following groups G in turn. The second presentation size of the images B of each group G is hereby advantageously constant within the respective group G, however decreases from group G to group G. This procedure is also shown from the start in FIGS. 3 and 4.

The procedure according to the invention possesses many advantages. In particular, it enables a very intuitive access by the user 5 to a large quantity of images B. The simultaneous presentation in presentation sizes that differ from one another hereby enables the navigation for the purposes of selection of images B and the precise presentation of images B to be implemented simultaneously. Because the simultaneous and adjacent presentation of the images B supports the orientation in the imaged anatomy or, respectively, in general in a functional context, the relatively large presentation of the images B in the internally contiguous sub-range T is a requirement for a reasonable evaluation of the images B of the internally contiguous sub-range T.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for presenting a sequence of images at a viewing device operated by a computer, comprising the steps of:
entering a selection command into the computer to designate an internally contiguous sub-range of images within said sequence;
from said computer, causing the images forming said internally contiguous sub-range of images to be displayed at said viewing device in a first presentation size that is uniform for all of said images that form said internally contiguous sub-range of images;
from said computer, automatically causing further images in said sequence, that are outside of said internally contiguous sub-range of images, to be displayed at said viewing device simultaneously with said images forming said images of said internally contiguous sub-range;
from said computer, causing said images outside of said internally contiguous sub-range to be presented at said viewing device in a second presentation size that is smaller than said first presentation size;
from said computer, causing a geometric arrangement of all of said images at said viewing device to form a geometric sequence; and
from said computer, causing an order of all of said images at said viewing device to coincide with an order of the images in said sequence of images.

2. A presentation method as claimed in claim 1 comprising supplying said sequence of images to said computer from an external source.

3. A presentation method as claimed in claim 1 comprising employing a single image as representing said internally contiguous sub-range.

4. A presentation method as claimed in claim 1 comprising, in said computer, automatically identifying said images that lie outside of said internally contiguous sub-range.

5. A presentation method as claimed in claim 1 wherein said sequence of images comprises a first image and a last image, and if said internally contiguous sub-range does not include either said first image or said last image, emitting from said computer at least one of said first or last images upstream and downstream of said internally contiguous sub-range at said viewing device simultaneously with the images forming said internally contiguous sub-range.

6. A presentation method as claimed in claim 1 comprising automatically monotonically decreasing a presentation size of respective images dependent on a distance of each image in said sequence from said internally contiguously sub-range.

7. A presentation method as claimed in claim 1 comprising presenting said images at said viewing device in an inwardly proceeding spiral, forming said geometric arrangement, starting from said internally contiguous sub-range.

8. A presentation method as claimed in claim 1 comprising automatically assembling said images of said sequence into groups, with a number of images at said viewing device in each group increasing with a distance of the respective group in said sequence from said internally contiguous sub-range.

9. A presentation method as claimed in claim 1 comprising employing, as said selection command, a shift instruction to shift the internally contiguous sub-range of the sequence.

10. A computer-readable medium encoded with programming instructions, said medium being loadable into a computer having an associated viewing device, and said programming instructions causing said computer to:
receive a selection command entered into the computer that designates an internally contiguous sub-range of images within said sequence;
cause the images forming said internally contiguous sub-range of images to be displayed at said viewing device in a first presentation size that is uniform for all of said images that form said internally contiguous sub-range of images;
cause further images in said sequence, that are outside of said internally contiguous sub-range of images, to be displayed at said viewing device simultaneously with said images forming said images of said internally contiguous sub-range;
cause said images outside of said internally contiguous sub-range to be presented at said viewing device in a second presentation size that is smaller than said first presentation size;
cause a geometric arrangement of all of said images at said viewing device to form a geometric sequence; and
cause an order of all of said images at said viewing device to coincide with an order of the images in said sequence of images.

11. A computer having an associated viewing device, said computer being programmed to:
receive a selection command entered into the computer that designates an internally contiguous sub-range of images within said sequence;
cause the images forming said internally contiguous sub-range of images to be displayed at said viewing device in a first presentation size that is uniform for all of said images that form said internally contiguous sub-range of images;
cause further images in said sequence, that are outside of said internally contiguous sub-range of images, to be displayed at said viewing device simultaneously with said images forming said images of said internally contiguous sub-range;
cause said images outside of said internally contiguous sub-range to be presented at said viewing device in a second presentation size that is smaller than said first presentation size;
cause a geometric arrangement of all of said images at said viewing device to form a geometric sequence; and
cause an order of all of said images at said viewing device to coincide with an order of the images in said sequence of images.
